(19) United States
(12) Patent Application Publication
(10) Pub. No.: US 2009/0322121 A1
(43) Pub. Date: Dec. 31, 2009

(54) Wind Deflector Mesh Device

(76) Inventors: Paul Queveau, Montravers (FR); Ludovic Vanacker, Breuil-Chaussee (FR)

Correspondence Address: MILES & STOCKBRIDGE PC, 1751 PINNACLE DRIVE, SUITE 500, MCLEAN, VA, 22102-3833, US

(21) Appl. No.: 11/991,775

(22) PCT Filed: Dec. 20, 2005
(86) PCT No.: PCT/EP2005/014213

§ 371 Date: Jul. 27, 2009

(30) Foreign Application Priority Data
Oct. 19, 2005 (FR) 0510664

(51) Int. Cl. B60N 2/44

(52) U.S. Cl. 296/180.1

(57) ABSTRACT

The invention relates to a wind deflector mesh device (3,4) designed to be disposed transversely to the conventional direction of advance of a vehicle and provided with fixing means (5, 6) for fixing to said vehicle, said wind deflector mesh device being characterized in that the fixing means (5, 6) are pouches designed to over the headrests (7) of the seats and integral with said mesh.

The invention relates to a wind deflector mesh device for a convertible vehicle.

When an automobile is a convertible, the air flowing closest to the windshield penetrates into the passenger compartment in part and inconveniences the occupants by wind-buffeting due to an eddying backflow or “backdraft” effect and to the turbulence generated.

In order to limit these effects, it is known that a mesh can be placed at the rear of the passenger compartment, the mesh being tensioned over a frame which is itself fixed removably to the body of the vehicle.

Putting such meshes in place is not easy because they must be tensioned between supports that need to be deployed above the seatbelts.

It is also known from Patent Document DE 103 41 852 that such a mesh can be placed on a reel positioned behind the back seats at the same level as the back shelf and/or on the floor of the vehicle between the front row and the back row of seats.

It can be understood that, at least when such a reel is placed on the floor, that reel degrades passenger comfort and constitutes an obstacle to boarding and to alighting from the vehicle.

The invention proposes a solution that is simple in particular in terms of how it is put in place and of how it is stowed away.

To this end, the invention provides a wind deflector mesh device designed to be disposed transversely to the conventional direction of advance of a vehicle and provided with fixing means for fixing to said vehicle, said wind deflector mesh device being characterized in that the fixing means are pouches designed to fit over the headrests of the seats.

The invention will be well understood on reading the following description given by way of non-limiting example and with reference to the accompanying drawings, in which:

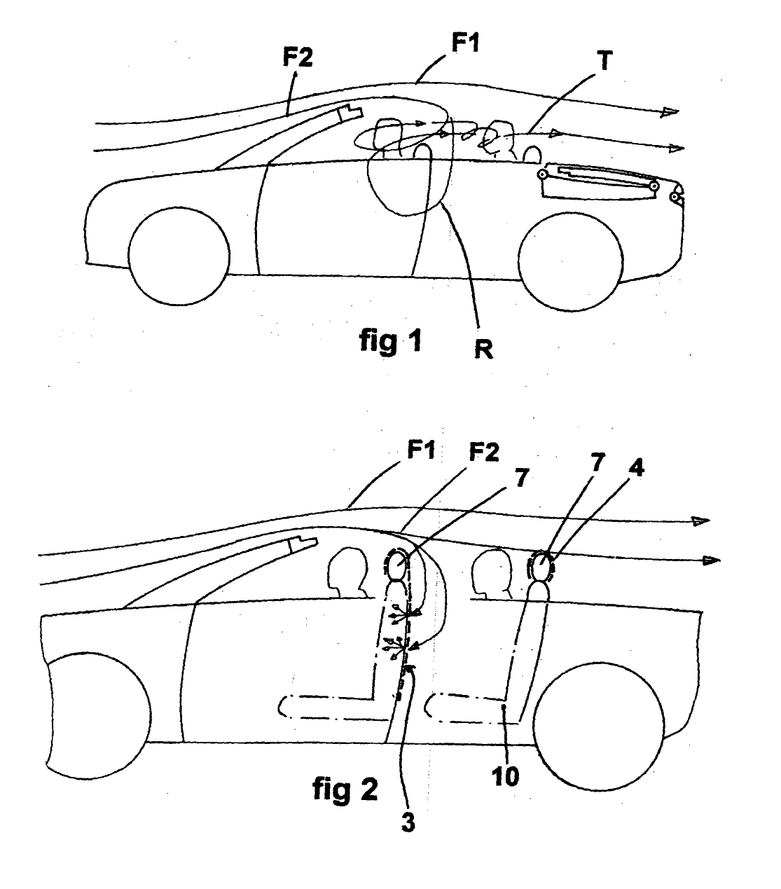

FIG. 1 is a view of the air flow in a convertible vehicle not equipped with a wind deflector mesh

FIG. 2 is a view of the air flow in a convertible vehicle equipped with a wind deflector mesh behind each row of seats;

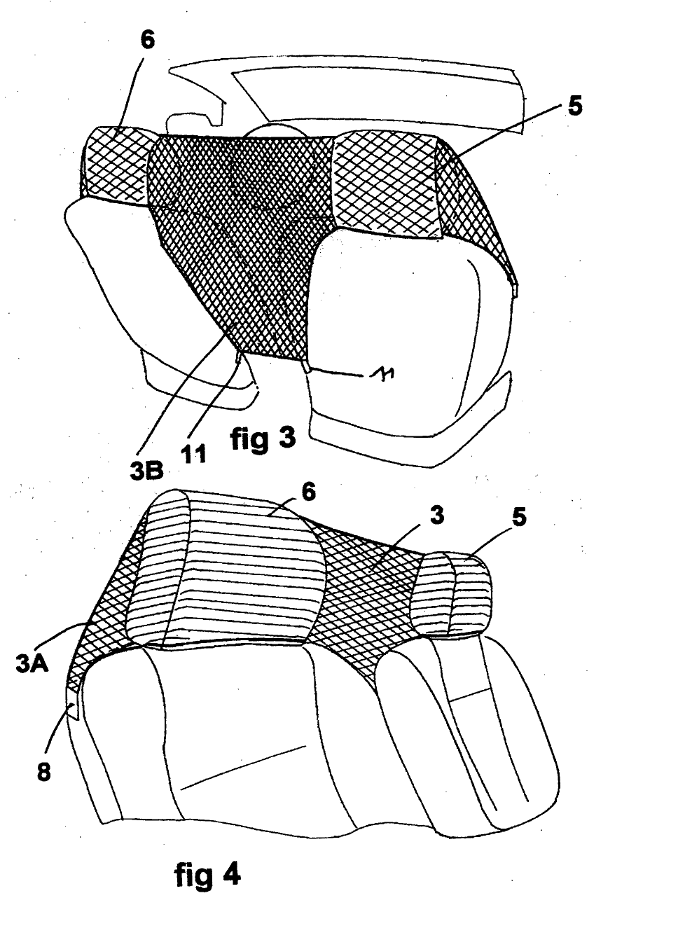

FIG. 3 is a rear quarter view of the front row of seats as provided with a mesh;

FIG. 4 is a front quarter view of the seats of FIG. 3;

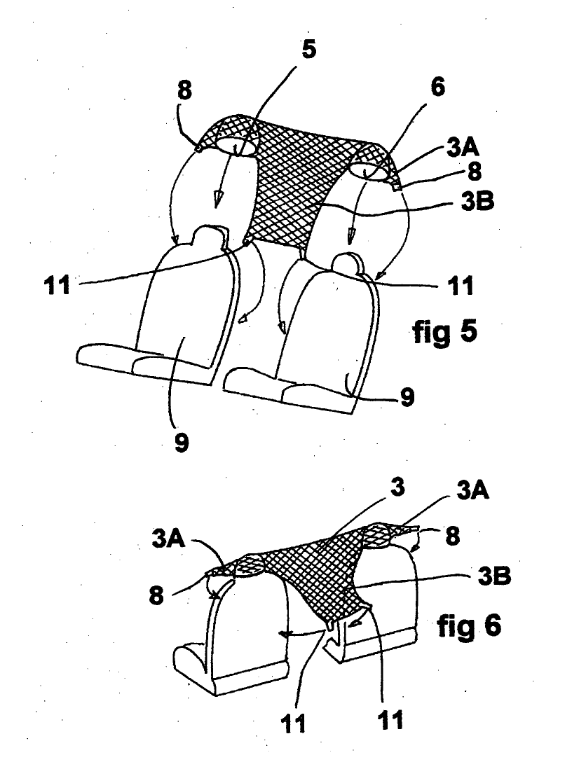

FIGS. 5 and 6 are views showing how a mesh is put in place on the front seats;

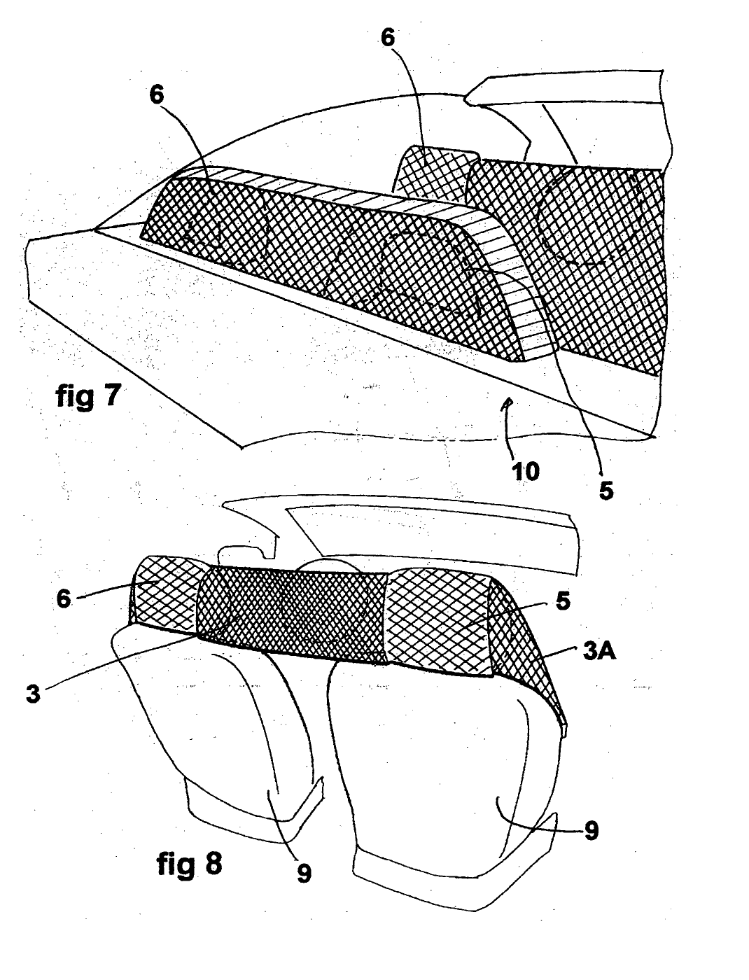

FIG. 7 is a rear quarter view of a vehicle equipped with a front mesh and with a back mesh; and

FIG. 8 is a rear view of a mesh mounted on the front seats.

FIG. 1 is a side view of a vehicle 1, showing the air flow.

A fraction F1 of the air flow passes over the passenger compartment without generating any disturbance. However, another fraction F2, closest to the top cross-piece of the windshield, causes turbulences T and backflow R.

In order to minimize these effects, a wind deflector mesh 3, 4 is used that is disposed transversely to the conventional direction of advance of a vehicle and that is provided with fixing means 5, 6 for fixing to said vehicle, said wind deflector mesh being characterized in that the fixing means are pouches designed to fit over the headrests 7 of the seats.

Said pouches 5, 6 fit over the headrests 7, thereby holding the mesh.

Several variant pouches exist. A first variant is an elastic pouch which, by means of its own elasticity clamps around the headrest, and a second variant is a pouch that is made of a non-elastic material but that is provided with tightening means for closing the pouch once it is in place.

Both these solutions make it easy to put the mesh in place and to remove it even if said mesh is of very low elasticity.

A version is also provided in which the mesh is elastically deformable so that its elasticity can contribute to facilitating putting the pouches in place. As is explained below, this elastic aspect is advantageous for the front seats.

Since the mesh or web is tensioned between the seats, its permeability to air stabilizes the flows and reduces the turbulences.

The mesh is preferably provided with two side flaps 3a, each of which extends on the outer side edge of a respective one of the headrests. They are fastened by conventional fastener means 8 of the type having hooks and loops that snag together and known under the trademark Velcro, or by other means such as press studs or “poppers”. The advantage of a fastener of the Velcro type is that it makes it possible to fasten the mesh along a line of the seat and thereby to provide sealing between the edges of the mesh and the seat, thereby improving effectiveness.

The meshes are thus fixed to the seats only, which is an advantage.

The meshes are installed on the front seats 9 and/or on the back seats 10.

When the mesh is placed in the front (FIGS. 3 to 7), it is advantageous to extend the mesh downwards so as substantially to close off the gap between the two seats, thereby controlling the backflow of air.

The mesh then has an apron 3b.

Fastener means 11 for fastening to the seat or to the structure of the seat are then provided at the base of the mesh.

FIG. 8 shows an example of a mesh without an apron 3b.

With the wind deflector mesh placed in this manner on the front seats and due to its elasticity, it is possible to move one front seat relative to the other without any problem and thus to access the back seats by tilting a front seat without having to remove the mesh. It also possible to adjust the inclination of each seat individually.

Naturally, for reasons of ease of putting in place and of removal, it is possible to use a mesh having low elasticity in the front because it is simple to remove it and to put it in place. The operation is as intuitive as putting on a hood.

The permeability of the mesh lies in the range 20% of its area to 50% of its area, i.e. the perforated area is in the range 20% of the total area to 50% of said total area.

This does not prevent communication between front-seat passengers and back-seat passengers, and does not hinder visibility very much.

As can be understood from the above, the mesh is simple to stow because it suffices to fold it up so that it occupies a small volume and so that it can be placed in the baggage compartment (trunk or boot) or in a small wrapper.

The pouches are made of the same material as the mesh, and are integral therewith.

In a variant of the mesh, when the mesh is of low elasticity, elastic zones are provided between the pouches and the mesh itself so as to facilitate fitting and removal and also so as to accommodate movements and tilting of the seat.

For example, relative to the example shown in FIG. 3 or FIG. 8, the mesh can extend below the headrests so as to accommodate movements of the headrests.

The pouches or portions of the pouches could be separate and mounted on the mesh.

1. A wind deflector mesh device (3, 4) adapted to be disposed transversely to the conventional direction of advance of a vehicle and having fixing means (5, 6) for fixing the device to said vehicle, said wind deflector mesh device being characterized in that the fixing means (5, 6) comprise pouches adapted to fit over headrests (7) of seats within the vehicle and said pouches being integral with said mesh.

2. A device according to claim 1, characterized in that the fixing means comprises two pouches and the mesh extends between the two pouches.

3. A device according to claim 1, characterized in that the pouches are made of an elastic material.

4. A device according to claim 1, characterized in that the pouches are of a non-elastic material.

5. A device according to claim 1 wherein the pouches further include tightening means for closing the pouches around the headrests of the seats after said pouches have been put in place over the headrests of the seats.

6. A device according to claim 1, characterized in that the mesh is elastically deformable.

7. A device according to claim 1, characterized in that the mesh and the pouches are made of the same material.

8. A device according to claim 1, characterized in that said pouches includes side flaps.

9. A device according to claim 1, characterized in that the mesh has an apron substantially closing the gap between the two front seats of a vehicle when the pouches have been placed over the headrests of the seats.

10. A device according to claim 1, characterized in that the mesh is adapted to be fixed to the seats only.

11. A device according to claim 1, characterized in that the pouches include fastener means (8) having hooks and loops that snag together.

12. A device according to claim 1, characterized in that the permeability of the mesh is in the range of 20% of its area to 50% of said area.

13. A device according to claim 1 characterized in that the mesh is non-elastic.

14. A device according to claim 1 characterized in that the pouches include fastener means of the press stud type.

15. A wind deflector device for a convertible vehicle adapted when in use to be disposed transversely to the conventional direction of advance of the vehicle, said device comprising a wind deflector mesh (3,4), a pair of pouches (5,6) adapted when in use to fit over headrests of a corresponding pair of seats within the vehicle, said deflector mesh being integral with the pouches and adapted when in use to extend between the two pouches and the seats of the vehicle when the pouches are disposed over the headrests.

16. A wind deflector device as set forth in claim 15 characterized in that the permeability of the mesh is in the range of 20% of its area to 50% of said area.

17. A wind deflector device as set forth in claim 15 characterized in that the pouches are elastically deformable to enable said pouches, when in use, to clamp around the head rests.

18. A wind deflector device as set forth in claim 15 wherein the pouches are of non-elastic material and include tightening means for closing the pouches when in use about the head rests of the corresponding pair of seats within the vehicle.

19. A wind deflector device as set forth in claim 15 characterized in that the mesh is elastically deformable.

20. A wind deflector device as set forth in claim 16 characterized in that the at least one of the pouches and mesh are comprised of an elastic material, said mesh further including an apron extending downward between the seats when in use to substantially close off any gap between the pair of seats.
